(19) United States
(12) Patent Application Publication
(10) Pub. No.: US 2017/0171307 A1
(43) Pub. Date: Jun. 15, 2017

(54) METHOD AND ELECTRONIC APPARATUS FOR PROCESSING PICTURE

(71) Applicants: Le Holdings (Beijing) Co., Ltd., Beijing (CN); LE SHI INTERNET INFORMATION TECHNOLOGY CORP. BEIJING, Beijing (CN)

(72) Inventor: Wei Xue, Beijing (CN)

(21) Appl. No.: 15/246,270

(22) Filed: Aug. 24, 2016

Related U.S. Application Data
(63) Continuation of application No. PCT/CN2016/088116, filed on Jul. 1, 2016.

(30) Foreign Application Priority Data
Dec. 9, 2015 (CN) 201510906769.4

(51) Int. Cl. H04L 29/08; G06T 1/00; G06T 3/40; H04L 12/26

(52) U.S. Cl. CPC H04L 67/1078; H04L 43/16; H04L 67/14; G06T 1/00; G06T 3/40; G06T 2200/16

(57) ABSTRACT

A method and electronic apparatus for processing picture, method includes: obtaining more than two assigned picture processing requests by picture processing server, generating more than two picture downloading tasks; detecting the existence of idle bandwidth resource greater than a first threshold value, the picture downloading task is executed, a downloaded picture corresponding to the picture downloading task is obtained; generating a picture operating task according to each downloaded picture; detecting the existence of process idle resource greater than the second threshold value, at least one picture operating task is executed, a downloaded picture corresponding to the picture operating task is processed, a processed picture is obtained; generating a picture uploading task according to processed picture; detecting the existence of the idle bandwidth resource greater than the third threshold value, at least one picture uploading task is executed, the processed picture corresponding to the picture uploading task is uploaded.

### CROSS REFERENCE TO RELATED APPLICATIONS

This application is a continuation of International Application No. PCT/CN2016/088116 filed on Jul. 1, 2016, which is based upon and claims priority to Chinese Patent Application No. 201510906769.4, filed on Dec. 9, 2015, the entire contents of which are incorporated herein by reference.

### TECHNICAL FIELD

The present disclosure relates to network technology, more particularly to a method and electronic apparatus for processing picture.

### BACKGROUND

With development of electronic technology and network technology, network and intelligence apparatus are popularized, pictures on internet are easily to be generated, there are a huge amount of new pictures generated in every day, and the proportion of the flow of access to these pictures in the total flow in internet is getting larger overtime.

To save the flow of access to pictures, a picture is usually in a reduced size version for client end to browse, in a traditional network architecture, various files including files uploaded by users or generated by websites are stored in network first, when these files include picture, a picture processing server will perform picture processing, the picture processing server will download pictures from the network storage in advance, and then the downloaded pictures will be processed with amendment of picture direction, renaming and picture compression etc., and the compressed picture will be uploaded to Node Servers in worldwide, the Node Server will generate a reduced-size picture and an access address of the reduced-size picture, so the client end is able to browse the reduced-size picture when the access address is obtained.

Accordingly, the picture processing server mainly has three operations for processing picture: downloading picture, processing picture and uploading picture, in traditional technologies, the picture processing server uses singlethreading operation for processing picture: downloading, processing and then uploading one picture at a time, however, with the increase of the amount of network pictures, this singlethreading operation is very unfavorable for efficiently processing pictures.

### SUMMARY

One embodiment of the present disclosure provides a method and electronic apparatus for processing picture for solving the problem of low efficiency in processing picture in traditional technology.

One embodiment of the present disclosure provides a method for processing picture, the method includes:

obtaining more than two assigned picture processing requests by a picture processing server to generate more than two respective picture downloading tasks;

detecting the existence of idle bandwidth resource, and wherein when the idle bandwidth resource is greater than a first threshold value, the at least one picture downloading task is executed, and a downloaded picture corresponding to the picture downloading task is obtained;

generating a picture operating task according to each downloaded picture;

detecting the existence of process idle resource, and wherein when the process idle resource is greater than a second threshold value, at least one picture operating task is executed, the downloaded picture corresponding to the picture operating task is processed, and processed picture is obtained;

generating a picture uploading task according to each processed picture;

detecting the existence of idle bandwidth resource, and wherein when the idle bandwidth resource is greater than a third threshold value, at least one picture uploading task is executed, the processed picture corresponding to the picture uploading task is uploaded.

One embodiment of the present disclosure provides a non-volatile computer storage medium capable of storing computer-executable instruction. The computer-executable instruction is used for performing any one of the method for processing picture as discussed in above.

One embodiment of the present disclosure provides an electronic apparatus, includes:

at least one processor and a memory; wherein the memory stores a computer-executable instruction which can be executed by the at least one processor. The instruction is performed by the at least one processor so that the at least one processor can perform any one of the method for processing picture as discussed in above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram illustrating a method for processing picture according to one embodiment of the present disclosure;

FIG. 2 is a flow diagram illustrating a method for processing picture according to another embodiment of the present disclosure;

FIG. 3 is a schematic view of an electronic apparatus for processing picture according to one embodiment of the present disclosure;

FIG. 4 is a schematic view of an electronic apparatus for processing picture according to another embodiment of the present disclosure; and

FIG. 5 is a schematic view of an electronic apparatus according to one embodiment of the present disclosure.

### DETAILED DESCRIPTION

For more clearly illustrating the purpose, technology and advantages of the present disclosure, the following paragraphs and related drawings are provided for thoroughly describing the features of the embodiments of the present disclosure. It is evident that these embodiments are merely illustrative and not exhaustive embodiments of the present disclosure. Based on the embodiments in the present disclosure, the other embodiments conceived by the people skilled in the art without putting inventive effort fall within the scope of the present disclosure.

One embodiment of the present disclosure is mainly used to process various pictures generated in network, files in network include files generated from websites or uploaded by users, and these files are firstly stored in network storing system. When the files in network storing system includes picture, a task engine end will output picture processing request for a picture processing server to process, there are plural picture processing servers clustered together. For balancing the loading, the task server is in charge of assigning picture processing requests. In actual application condition, the task server used to balance the loading can be a nginx server (engine x, a web server and reverse proxy server with high performance), and the picture processing server can be a resin server (an application server).

The picture processing server downloads, processes and uploads picture to a Node Server, wherein, the Node Server can be one of CDN (Content Delivery Network, Content Delivery Network) servers distributed worldwide, the Node Server generates reduced-size pictures and access addresses of the reduced-size pictures to the network storing system, when a client end obtains the access address of the reduced-size picture, and then the reduced-size picture can be browsed.

Singlethreading operation is the traditional way for the picture processing server to process pictures, after any one of pictures is downloaded, processed and uploaded, then the other pictures are processed, and when not only one picture processing request is assigned to the picture processing server, efficiency of picture processing is largely affected.

For solving this problem, developers provide the present disclosure, in one embodiment of the present disclosure, a picture processing server builds respective picture downloading tasks according to each picture processing request assigned by the task server; builds a picture operating task for each downloaded picture downloaded by executing the picture downloading task; builds the picture uploading task for each processed picture obtained by executing the picture operating task. By detecting the idle bandwidth resource, the detection can be a real-time detection or a periodic detection, when detecting the existence of the idle bandwidth resource, the picture downloading task or the picture uploading task can be executed, when detecting the existence of the process idle resource, the picture operating task can be executed, it is no need wait until one picture is finished to be downloaded, processed and then uploaded in one picture processing request to execute next picture processing request, pictures can be downloaded, processed or uploaded as long as the idle resource exists, which achieving multithreading operation, full utilization of resources and high efficiency in processing picture.

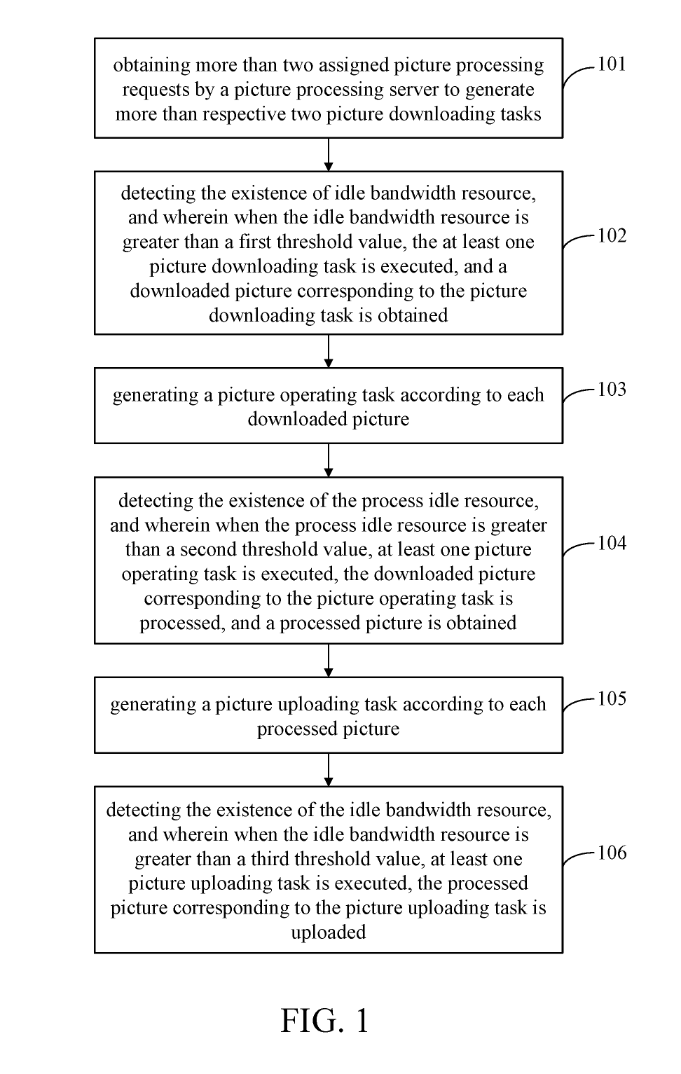

FIG. 1 is a flowchart of a method for processing picture according to one embodiment of the present disclosure, the method includes the following steps:

101: obtaining more than two assigned picture processing requests by a picture processing server to generate more than two respective picture downloading tasks.

The picture processing requests are assigned by the task server.

Wherein, the more than two picture processing requests include a condition having two picture processing requests.

In an actual application condition, the task server can be an nginx server mainly used for balancing the loading of picture processing, and assigning picture processing requests to the picture processing server from a server cluster. The picture processing server can be a resin server.

After the picture processing server receives more than two picture processing requests, for each picture processing request, respective picture downloading tasks will be generated for downloading picture.

102: detecting the existence of idle bandwidth resource, and wherein when the idle bandwidth resource is greater than a first threshold value, the at least one picture downloading task is executed, and a downloaded picture corresponding to the picture downloading task is obtained.

The detection can be a real-time detection or a periodic detection, the picture downloading executed by the picture downloading task is to obtain picture corresponding to the picture processing request from the network storing system.

In this embodiment, the bandwidth resource can be monitored. Once the existence of idle bandwidth resource is detected, the at least one picture downloading task can be executed.

Wherein, the first threshold value can be set according to bandwidth resource required in executing one picture downloading task.

The at least one picture downloading task can be determined according to the quantity of the idle bandwidth resource.

When the idle bandwidth resource does not exist, or the idle bandwidth resource is less than first threshold value, the monitoring can be continued until the idle bandwidth resource exists, and the idle bandwidth resource is greater than the first threshold value, and then the picture downloading task is executed.

103: generating a picture operating task according to each downloaded picture.

After the downloaded picture is obtained, the downloaded picture can be processed, thus the picture operating task corresponding to each downloaded picture is generated.

104: detecting the existence of the process idle resource, and wherein when the process idle resource is greater than a second threshold value, at least one picture operating task is executed, the downloaded picture corresponding to the picture operating task is processed, and a processed picture is obtained.

The process idle resource is the idle process resource in the picture processing server, picture processing needs to occupy process resource of the picture processing server.

One embodiment of the present disclosure is able to monitor process resource of the picture processing server, when the process idle resource exists, at least one picture operating task can be executed.

Wherein, the second threshold value can be set according to the process resource required in executing one picture operating task.

The at least one picture operating task can be determined according to the amount of the process idle resource.

When the process idle resource does not exist, or the process idle resource is less than the second threshold value, the monitoring can be continued until the process idle resource exists and the process idle resource is greater than the second threshold value, and the picture operating task is then executed.

The downloaded picture is processed with amendment of picture direction, renaming and picture compression etc., which are the same as the current technology and not discussed here.

105: generating a picture uploading task according to each processed picture.

106: detecting the existence of the idle bandwidth resource, and wherein when the idle bandwidth resource is greater than a third threshold value, at least one picture uploading task is executed, the processed picture corresponding to the picture uploading task is uploaded.

When the processed picture is obtained, the picture uploading task corresponding to each processed picture is generated.

The picture uploading task also occupies the idle bandwidth resource, so at least one picture uploading task can be executed when the existence of the idle bandwidth resource is monitored.

Wherein, the third threshold value can be set according to bandwidth resource required in executing one picture uploading task.

When the idle bandwidth resource does not exist, or the idle bandwidth resource is less than the third threshold value, the monitoring can be continued until the idle bandwidth resource exists or the idle bandwidth resource is greater than the third threshold value, and the picture uploading task is then executed.

Wherein, the processed picture is uploaded to the Node server, and the Node server is able to generate reduced-size picture and access addresses of the reduced-size picture.

In one embodiment of the present disclosure, when more than two picture processing requests are obtained, the picture downloading task is firstly built, the picture processing task corresponding to the downloaded picture is built, respective picture uploading task for the processed picture is built, when detecting the existence of the idle bandwidth resource, the picture downloading task or the picture uploading task can be executed, when detecting the existence of the process idle resource, the picture operating task can be executed, there is no need to wait until one picture is finished to be downloaded, processed and then uploaded in one picture processing request to execute next picture processing request, pictures can be downloaded, processed or uploaded as long as the idle resource exists, which achieving multithreading operation, full utilization of resources and high efficiency in processing picture.

Both picture downloading and picture uploading need to occupy bandwidth resource, for reasonable assigning the picture downloading task and the picture uploading task, another embodiment is provided, the third threshold value can be less than the first threshold value, so the picture uploading task can be executed first.

Of course, according to different actual conditions, the third threshold value can be greater than the first threshold value, so the picture downloading task can be executed first.

In addition, in another embodiment, for firstly executing the picture uploading task to ensure that one picture processing request can be finished, the step that the existence of the idle bandwidth resource is detected, when the idle bandwidth resource is greater than the first threshold value, the at least one picture downloading task is executed to download picture, and the downloaded picture is obtained, is able to:

detect the existence of the idle bandwidth resource, and when the idle bandwidth resource is greater than the first threshold value, at least one picture uploading task is firstly executed if the picture uploading task exists, and the processed picture corresponding to the at least one picture uploading task is uploaded;

if the picture uploading task does not exist, the at least one picture downloading task is executed to download picture, and the downloaded picture corresponding to the picture downloading task is obtained.

wherein, if more than two picture downloading tasks exist, the step that the existence of the idle bandwidth resource is detected, when the idle bandwidth resource is greater than the first threshold value, the at least one picture downloading task is executed, and the downloaded picture corresponding to the picture downloading task is obtained, is able to:

detect the existence of the idle bandwidth resource, and when the idle bandwidth resource is greater than first threshold value, according to download priority from high to low, the at least one picture downloading task is executed, and the downloaded picture corresponding to the picture downloading task is obtained.

The download priority can be set and informed to the picture processing server by the task server, or can be set by the picture processing server.

The download priority can be set according to the source of the pictures, for example, the download priority of the picture from computer is higher than the download priority of the picture from movable end.

The step that the existence of the process idle resource is detected, when the process idle resource is greater than the second threshold value, at least one picture operating task is executed, the downloaded picture corresponding to the picture operating task is processed, and the processed picture is obtained, is able to:

detect the existence of the process idle resource, and when the process idle resource is greater than the second threshold value, according to operate priority from high to low, at least one picture operating task is executed, the downloaded picture corresponding to the picture operating task is processed, and the processed picture is obtained;

the step that the existence of the idle bandwidth resource is detected, when the idle bandwidth resource is greater than the third threshold value, at least one picture uploading task is executed, and the processed picture corresponding to the picture uploading task is uploaded, can include:

detect the existence of the idle bandwidth resource, and when the idle bandwidth resource is greater than the third threshold value, according to upload priority from high to low, at least one picture uploading task is executed, and the processed picture corresponding to the picture uploading task is uploaded.

The settings of the operate priority and the upload priority can be the same as the setting of the download priority.

Of course, in the operate priority; the priority of former downloaded picture is higher than the priority of latter downloaded picture. In the upload priority; the priority of former processed picture is higher than the priority of letter processed picture.

Wherein, for ensuring picture downloading, picture processing and picture uploading can be executed in sequence. After the picture downloading task is generated, the method further includes:

adding each picture downloading task into a built picture download queue;

after the picture operating task is generated, the method further includes:

adding each picture operating task into a built picture operate queue;

after the picture uploading task is generated, the method further includes:

adding each picture uploading task into a built picture upload queue;

the step that the existence of the idle bandwidth resource is detected, when the idle bandwidth resource is greater than the first threshold value, the at least one picture downloading task is executed, and the downloaded picture corresponding to the picture downloading task is obtained, can be:

detecting the existence of the idle bandwidth resource, and when the idle bandwidth resource is greater than the first threshold value, the at least one picture downloading task in the download queue is obtained and executed, and the downloaded picture corresponding to the picture downloading task is obtained;

the step that the existence of the process idle resource is detected, when the process idle resource is greater than the second threshold value, at least one picture operating task is executed, the downloaded picture corresponding to the picture operating task is processed, and the processed picture is obtained, can be:

detecting the existence of the process idle resource, when the process idle resource is greater than the second threshold value, at least one picture operating task in the picture operate queue is obtained and executed, the downloaded picture corresponding to the picture operating task is processed, and the processed picture is obtained;

the step that the existence of the idle bandwidth resource is detected, when the idle bandwidth resource is greater than the third threshold value, at least one picture uploading task is executed, and the processed picture corresponding to the picture uploading task is uploaded, can be:

detecting the existence of the idle bandwidth resource, when the idle bandwidth resource is greater than the third threshold value, at least one picture uploading task in the picture upload queue is obtained and executed, and the processed picture corresponding to the picture uploading task is uploaded.

In the picture download queue, each picture downloading task can be arranged according to the download priority, so the picture downloading tasks can be directly sequentially obtained from the picture download queue.

In the picture operate queue, each picture operating task can be arranged according to the operate priority, so the picture downloading tasks can be directly sequentially obtained from the picture operate queue.

In the picture upload queue, each picture uploading task can be arranged according to upload priority, so picture uploading tasks can be directly sequentially obtained from the picture operate queue.

Wherein, in another embodiment, picture can fail to be downloaded, so when the idle bandwidth resource exists, and the idle bandwidth resource is greater than the first threshold value, the at least one picture downloading task is executed to download picture, after the downloaded picture is obtained, the method further includes:

reexecuting the picture downloading task after any one of the picture downloading tasks fails to be executed;

generating error downloading information to the task server after the picture downloading task continuously fails to be executed over a first predetermined number of times.

The task server will send feedback to the task engine end, the task engine end is able to regenerate picture processing request according to the picture processing request corresponding to the failed picture downloading task, and the picture processing request can be assigned and processed by the task server.

In another embodiment, picture can fail to be uploaded, so when the idle bandwidth resource exists, and wherein when the idle bandwidth resource is greater than the third threshold value, the at least one picture downloading task is executed to download picture, after the downloaded picture is obtained, the method further includes:

reexecuting the picture uploading task when any one of the picture uploading tasks fails to be executed;

generating error uploading information to the task server after the picture uploading task continuously fails to be executed over a second predetermined number of times.

The task server will send feedback to the task engine end, the task engine end is able to regenerate picture processing request according to the picture processing request corresponding to the failed picture uploading task, and the picture processing request can be assigned and processed by the task server.

When the picture processing server uploads the processed picture corresponding to the picture uploading task, the processed picture is uploaded to the Node server, the Node server can be one of CDN servers in worldwide, the Node server can upload picture and then generate reduced-size picture and access address of the reduced-size picture, and send the access address of the reduced-size picture back to the picture processing server, the access address of the reduced-size picture is sent back to the task server by the picture processing server, and then is sent to picture storing system by the task server, when a client end requests to browse picture, the picture storing system will send the access address of the reduced-size picture to the client end, so the client end is able to browse the reduced-size picture.

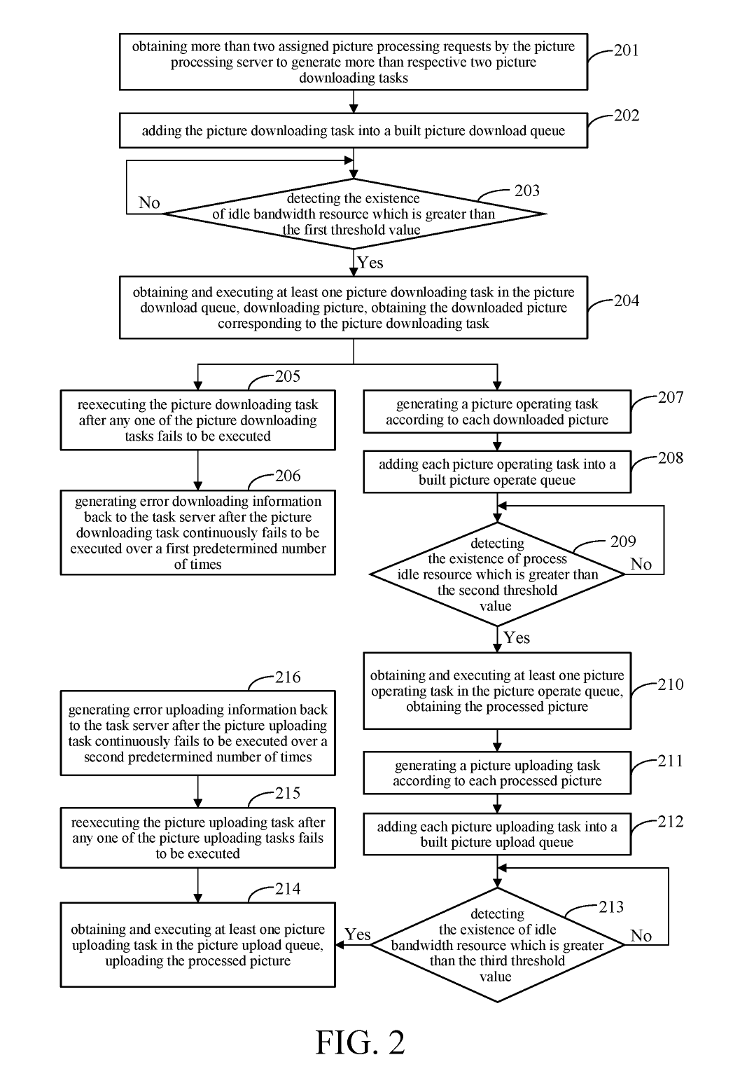

In combination with FIG. 2, there is another embodiment of the method of processing picture provided by the present disclosure, the method may include the following steps:

201: obtaining more than two assigned picture processing requests by the picture processing server to generate more than two respective picture downloading tasks.

202: adding the picture downloading task into a built picture download queue.

203: detecting the existence of idle bandwidth resource which is greater than the first threshold value, if yes, the step 204 is executed, if no, the detecting is continued.

204: obtaining and executing at least one picture downloading task in the picture download queue, downloading picture, obtaining the downloaded picture corresponding to the picture downloading task.

205: reexecuting the picture downloading task after any one of the picture downloading tasks fails to be executed;

206: generating error downloading information back to the task server after the picture downloading task continuously fails to be executed over a first predetermined number of times.

207: generating a picture operating task according to each downloaded picture.

208: adding each picture operating task into a built picture operate queue.

209: detecting the existence of process idle resource which is greater than the second threshold value, if yes, the step 210 if executed, if no, the detecting is continued.

210: obtaining and executing at least one picture operating task in the picture operate queue, processing the downloaded picture corresponding to the picture operating task, obtaining the processed picture.

211: generating a picture uploading task according to each processed picture.

212: adding each picture uploading task into a built picture upload queue.

213: detecting the existence of idle bandwidth resource which is greater than the third threshold value, if yes, the step 214 is executed, if no, the detecting is continued.

214: obtaining and executing at least one picture uploading task in the picture upload queue, uploading the processed picture corresponding to the picture uploading task.

215: reexecuting the picture uploading task after any one of the picture uploading tasks fails to be executed;

216: generating error uploading information back to the task server after the picture uploading task continuously fails to be executed over a second predetermined number of times.

By one embodiment of the present disclosure, resources can be fully utilized, and efficiency in processing picture is improved.

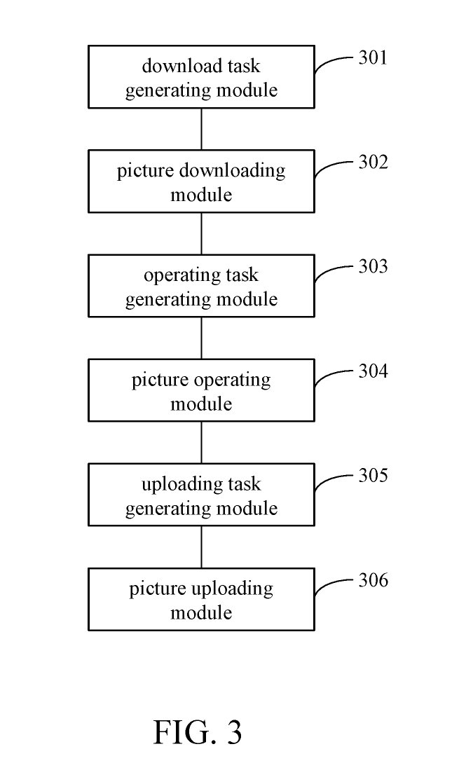

FIG. 3 is a schematic view of an electronic apparatus for processing picture according to one embodiment of the present disclosure, the electronic apparatus of this embodiment is mainly adapted to picture processing server, the picture processing server can be a resin server, the electronic apparatus may include:

a download task generating module 301 used to obtain more than two assigned picture processing requests to generate more than two respective picture downloading tasks.

In an actual application, the task server can be an nginx server used for balancing the loading of processing picture, and assigning picture processing requests to the picture processing server from a server cluster.

a picture downloading module 302 used to detect the existence of the idle bandwidth resource, and when the idle bandwidth resource is greater than the first threshold value, the at least one picture downloading task is executed, and the downloaded picture corresponding to the picture downloading task is obtained.

In one embodiment of the present disclosure, the bandwidth resource can be monitored. Once the existence of idle bandwidth resource is detected, the at least one picture downloading task can be executed.

Wherein, the first threshold value can be set according to bandwidth resource required in executing one picture downloading task.

The at least one picture downloading task can be determined according to the quantity of the idle bandwidth resource.

When the picture downloading module detects that the idle bandwidth resource does not exist, or the idle bandwidth resource is less than the first threshold value, the monitoring can be continued until the idle bandwidth resource exists, and the idle bandwidth resource is greater than the first threshold value, and the picture downloading task is then executed.

The operating task generating module 303 is used to generate a picture operating task according to each downloaded picture.

The picture operating module 304 is used to detect the existence of the process idle resource, and when the process idle resource is greater than the second threshold value, at least one picture operating task is executed, the downloaded picture corresponding to the picture operating task is processed, and the processed picture is obtained.

The process idle resource means the idle process resource in the picture processing server, execution of processing picture needs to occupy process resource of picture processing server.

One embodiment of the present disclosure is able to monitor process resource of the picture processing server, when the process idle resource exists, at least one picture operating task can be executed.

Wherein, the second threshold value can be set according to the process resource required in executing one picture operating task.

The at least one picture operating task can be determined according to the amount of the process idle resource.

When the picture operating module detects that the process idle resource does not exist, or the process idle resource is less than the second threshold value, the monitoring can be continued until the process idle resource exists or the process idle resource is greater than the second threshold value, and the picture operating task is then executed.

The downloaded picture is processed with amendment of picture direction, renaming and picture compression etc., which are the same as the current technology and not discussed here.

The uploading task generating module 305 is used to generate a picture uploading task according to each processed picture;

The picture uploading module 306 is used to detect the existence of the idle bandwidth resource, and when the idle bandwidth resource is greater than the third threshold value, at least one picture uploading task is executed, and the processed picture corresponding to the picture uploading task is uploaded.

The picture uploading task also occupies the idle bandwidth resource, so at least one picture uploading task can be executed when the existence of the idle bandwidth resource monitored.

Wherein, the third threshold value can be set according to bandwidth resource required in executing one picture uploading task.

When the picture uploading module detects that the idle bandwidth resource does not exist, or the idle bandwidth resource is less than the third threshold value, the monitoring can be continued until the idle bandwidth resource exists or the idle bandwidth resource is greater than the third threshold value, and the picture uploading task is then executed.

In one embodiment of the present disclosure, when more than two picture processing requests are received, the picture downloading task is firstly built, a picture processing task corresponding to the downloaded picture is built, respective picture uploading task for the processed picture is built, by detecting the idle bandwidth resource, the detection can be a real-time detection or a periodic detection, when the existence of the idle bandwidth resource is detected, the picture downloading task or the picture uploading task is executed, when the existence of the process idle resource is detected, the picture operating task is executed, there is no need to wait until one picture is finished to be downloaded, processed and uploaded in one picture processing request to execute next picture processing request, pictures can be downloaded, processed or uploaded as long as the idle resource exists, which achieving multithreading operation, full utilization of resources and high efficiency in processing picture.

Both picture downloading and picture uploading need to occupy bandwidth resource, for reasonable assigning the picture downloading task and the picture uploading task, another embodiment is provided, the third threshold value can be less than the first threshold value, so the picture uploading task can be executed first.

Of course, according to different actual conditions, the third threshold value can be greater than the first threshold value, so the picture downloading task can be executed first.

In addition, in another embodiment, for firstly executing the picture uploading task to ensure that one picture processing request can be finished, the picture downloading module can be used to:

detect the existence of the idle bandwidth resource, and when the idle bandwidth resource is greater than the first threshold value, if the picture uploading task exists, the picture uploading module is firstly triggered to execute at least one picture uploading task, and the processed picture corresponding to the at least one picture uploading task is uploaded;

if the picture uploading task does not exist, the at least one picture downloading task is executed to download picture, and the downloaded picture corresponding to the picture downloading task is obtained.

Wherein, if more than two picture downloading tasks exist, and the picture downloading module can be used to:

detect the existence of the idle bandwidth resource, and when the idle bandwidth resource is greater than the first threshold value, according to download priority from high to low, the at least one picture downloading task is executed to download picture, and the downloaded picture corresponding to the picture downloading task is obtained;

The download priority can be set and informed to picture processing server by the task server, or can be set by the picture processing server.

The download priority can be set according to the source of the pictures, for example, the download priority of the picture from computer is higher than the download priority of the picture from movable end.

The picture operating module can be used to:

detect the existence of the process idle resource, and when the process idle resource is greater than the second threshold value, according to operate priority from high to low, at least one picture operating task is executed, the downloaded picture corresponding to the picture operating task is processed, and the processed picture is obtained;

The picture uploading module is used to:

detect the existence of the idle bandwidth resource, and when the idle bandwidth resource is greater than the third threshold value, according to upload priority from high to low, at least one picture uploading task is executed, and the processed picture corresponding to the picture uploading task is uploaded.

The settings of the operate priority and the upload priority can be the same as the setting of the download priority.

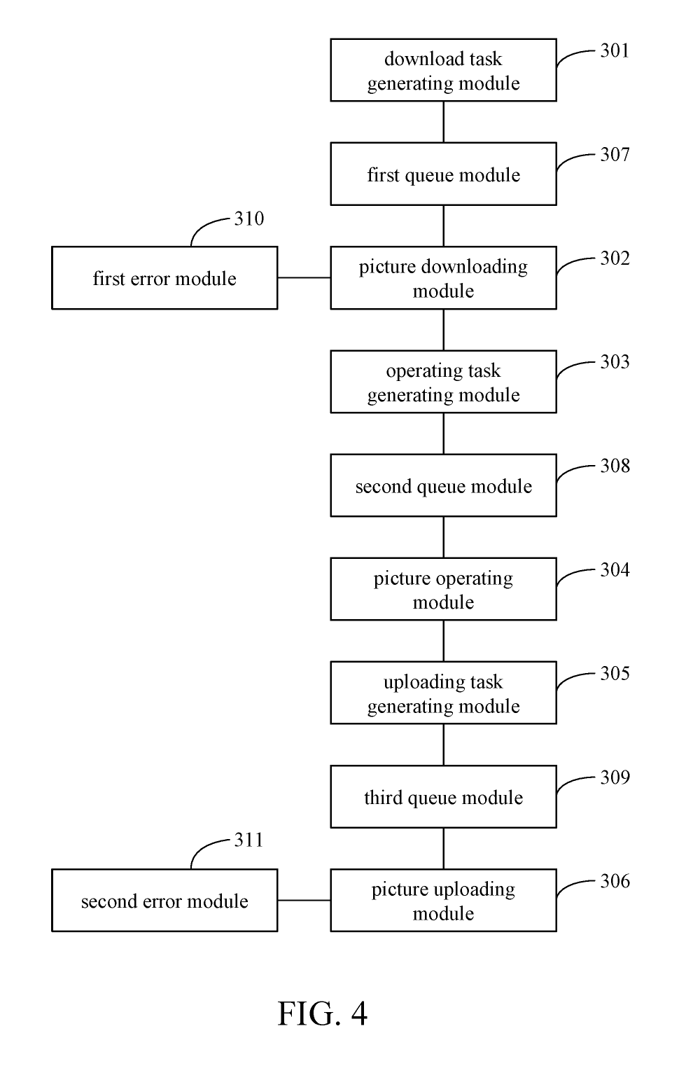

Of course, in the operate priority, the priority of former downloaded picture can be higher than the priority of latter downloaded picture. In the upload priority, the priority of former processed picture can be higher than the priority of letter processed picture.

Wherein, for ensuring the picture downloading, processing and uploading can be executed in sequence. As shown in FIG. 4, the electronic apparatus may include:

a first queue module 307 used to add each picture downloading task into a built picture download queue;

a second queue module 308 used to add each picture operating task into a built picture operate queue;

a third queue module 309 used to add each picture uploading task into a built picture upload queue;

The picture downloading module 302 can be used to:

detect the existence of the idle bandwidth resource, and when the idle bandwidth resource is greater than the first threshold value, the at least one picture downloading task in the download queue is obtained and executed, the downloaded picture corresponding to the picture downloading task is obtained;

The picture operating module 304 can be used to:

detect the existence of process idle resource, and when the process idle resource is greater than the second threshold value, at least one picture operating task in the picture operate queue is executed, the downloaded picture corresponding to the picture operating task is processed, and the processed picture is obtained;

The picture uploading module 306 can be used to:

detect the existence of idle bandwidth resource, and when the idle bandwidth resource is greater than the third threshold value, at least one picture uploading task in the picture upload queue is executed, the processed picture corresponding to the picture uploading task is uploaded.

Wherein, in another embodiment, picture can fail to be downloaded, thus, by the picture downloading module 302, when the idle bandwidth resource exists, and the idle bandwidth resource is greater than the first threshold value, the at least one picture downloading task is executed, after the downloaded picture is obtained, the picture downloading module 302 is also can be used to reexecute the picture downloading task after any one of the picture downloading tasks fails to be executed;

As shown in FIG. 4, the electronic apparatus may further include:

a first error module 310 used to generate error downloading information back to the task server after the picture downloading task continuously fails to be executed over a first predetermined number of times.

The task server will send feedback to the task engine end, the task engine end is able to regenerate picture processing request according to the picture processing request corresponding to the failed picture downloading task, and the picture processing request can be assigned and processed by the task server.

In another embodiment, picture can fail to be uploaded, thus, by the picture uploading module 306, when the idle bandwidth resource exists, at least one picture uploading task is executed, and after the processed picture corresponding to the picture uploading task is uploaded, the picture uploading task is reexecuted after any one of the picture uploading tasks fails to be executed;

As shown in FIG. 4, the electronic apparatus may further include:

a second error module 311 used to generate error uploading information back to the task server after the picture uploading task continuously fails to be executed over the second predetermined number of times.

The task server will send feedback to the task engine end, the task engine end is able to regenerate picture processing request according to the picture processing request corresponding to the failed picture downloading task, and the picture processing request can be assigned and processed by the task server.

Wherein, the picture uploading module can upload the processed picture corresponding to the picture uploading task, in specific, the processed picture is uploaded to the Node server, the Node server can be one of CDN servers distributed worldwide, the Node server is able to upload picture, and then generate reduced-size picture and access address of the reduced-size picture, and send the access address of the reduced-size picture back to the electronic apparatus for processing picture, the electronic apparatus for processing picture then sends the access address of the reduced-size picture back to the task server, the task server then sends feedback to the picture storing system, when the client end requests to browse picture, the picture storing system sends the access address of the reduced-size picture back to the client end, so the client end is able to browse the reduced-size picture.

One embodiment of the present disclosure provides a picture processing system, including the picture processing server, the task engine end, the task server and the Node server;

The picture processing server is equipped with the electronic apparatus for processing picture corresponding to the embodiments as shown in FIG. 3 or FIG. 4.

The task server is used to assign picture processing requests to the picture processing server, receive the error downloading information and the error uploading information of the picture processing server, and transmit the error downloading information and the error uploading information to the task engine end;

The task engine end is used to detect whether picture exists in the network storing system, generate picture processing request; regenerate picture processing request according to the error downloading information and the error uploading information; and trigger the task server to assign the picture processing requests;

The Node server is used to receive picture uploaded from the picture processing server, and generate reduced-size picture and access address of the reduced-size picture.

Thus, when the client end is browsing pictures, the client end is able to browse the reduced-size picture according to the access address of the reduced-size picture.

By the technical solution of one embodiment of the present disclosure, resources can be fully utilized, and efficiency in processing picture is improved.

The aforementioned embodiments are exemplary, the description of separated units can be physically connected, and the unit capable of displaying image can not be a physical unit, that is, it can be located on a place or distributed to plural internet units. It can be understood and performed by the people skilled in the art without putting inventive effort.

One embodiment of the present disclosure provides a non-volatile computer storage medium capable of storing computer-executable instruction. The computer-executable instruction is used for performing any one of the method for processing picture as discussed in above.

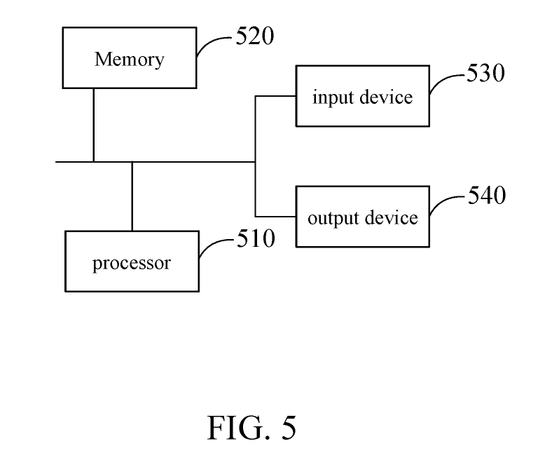

FIG. 5 is a schematic view of an electronic apparatus of one embodiment of the present disclosure, as shown in FIG. 5, the electronic apparatus includes:

a memory 520 and one or more processors 510. FIG. 5 is an example showing that the electronic apparatus having one processor 510.

The electronic apparatus includes: an input device 530 and an output device 540.

The processor 510, the memory 520, the input device 530 and the output device 540 can be connected to each other via a bus or other members for electrical connection. In FIG. 5, they are connected to each other via the bus in this embodiment.

The memory 520 is one kind of non-volatile computer-readable storage medium applicable to store non-volatile software programs, non-volatile computer-executable programs and modules; for example, the program instructions and the function modules (the download task generating module 301 and the picture downloading module 302 in FIG. 3) corresponding to the method in the embodiments are respectively a computer-executable program and a computer-executable module. The processor 510 executes function applications and data processing of the server by running the non-volatile software programs, non-volatile computer-executable programs and modules stored in the memory 520, and thereby the methods in the aforementioned embodiments are achievable.

The memory 520 can include a program storage area and a data storage area, wherein the program storage area can store an operating system and at least one application program required for a function; the data storage area can store the data created according to the usage of the device for intelligent recommendation. Furthermore, the memory 520 can include a high speed random-access memory, and further include a non-volatile memory such as at least one disk storage member, at least one flash memory member and other non-volatile solid state storage member. In some embodiments, the memory 520 can have a remote connection with the processor 510, and such memory can be connected to the device of the present disclosure by a network. The aforementioned network includes, but not limited to, internet, intranet, local area network, mobile communication network and combination thereof.

The input device 530 can receive digital or character information, and generate a key signal input corresponding to the user setting and the function control of the device for intelligent recommendation. The output device 540 can include a displaying unit such as screen.

The one or more modules are stored in the memory 520. When the one or more modules are executed by one or more processor 510, the methods disclosed in any one of the embodiments is performed.

The aforementioned product can perform the method of the present disclosure, and has function module for performing it. The details not thoroughly illustrated in this embodiment can be referenced via the methods in the present disclosure.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The aforementioned embodiments are exemplary, the description of separated units can be physically connected, and the unit capable of displaying image can not be a physical unit, that is, it can be located on a place or distributed to plural internet units. It is selectively to select a part or all of the modules for achieving the purpose of the present disclosure.

By the aforementioned embodiments, the people skilled in the art can thoroughly understand that the embodiments can be implemented by software and hardware platform. Accordingly, the technique, features or the part having contribution can be embodied through software product, the software product can be stored in computer readable medium, such as ROM/RAM, hard disk, optical disc, including one or more instructions so that a computing apparatus (e.g. personal computer, server, or internet apparatus) can execute each embodiment or some methods discussed the embodiments.

It is further noted that: the embodiments in above are only used to explain the features of the present application, but not used to limit the present application; although the present application is explained by the embodiments, the people skilled in the art would know that the features in the aforementioned embodiments can be modified, or a part of the features can be replaced, and the features relating to these modification or replacement are still in the scope and spirit of the present application.

What is claimed is:

1. A method for processing picture, applied to an electronic apparatus, the method comprising:
obtaining more than two assigned picture processing requests by a picture processing server to generate more than two respective picture downloading tasks;
detecting the existence of idle bandwidth resource, wherein when the idle bandwidth resource is greater than a first threshold value, the at least one picture downloading task is executed, and a downloaded picture corresponding to the picture downloading task is obtained;
generating a picture operating task according to each downloaded picture;
detecting the existence of process idle resource, and wherein when the process idle resource is greater than a second threshold value, at least one picture operating task is executed, the downloaded picture corresponding to the picture operating task is processed, and a processed picture is obtained;
generating a picture uploading task according to each processed picture;
detecting the existence of the idle bandwidth resource, and wherein when the idle bandwidth resource is greater than a third threshold value, at least one picture uploading task is executed, and the processed picture corresponding to the picture uploading task is uploaded.

2. The method according to claim 1, wherein, the step that the existence of idle bandwidth resource is detected, when the idle bandwidth resource is greater than the first threshold value, the at least one picture downloading task is executed, and the downloaded picture corresponding to the picture downloading task is obtained, comprising:
detecting the existence of the idle bandwidth resource, wherein when the idle bandwidth resource is greater than the first threshold value, according to download priority from high to low, the at least one picture downloading task is executed, and the downloaded picture corresponding to the picture downloading task is obtained;
the step that the existence of the process idle resource is detected, when the process idle resource is greater than the second threshold value, at least one picture operating task is executed, the downloaded picture corresponding to the picture operating task is processed, and the processed picture is obtained, comprising:
detecting the existence of the process idle resource, wherein when the process idle resource is greater than the second threshold value, according to operate priority from high to low, at least one picture operating task is executed, the downloaded picture corresponding to the picture operating task is processed, and the processed picture is obtained;
the step that the existence of the idle bandwidth resource is detected, when the idle bandwidth resource is greater than the third threshold value, at least one picture uploading task is executed, and the processed picture corresponding to the picture uploading task is uploaded, comprising:
detecting the existence of the idle bandwidth resource, and wherein when the idle bandwidth resource is greater than the third threshold value, according to upload priority from high to low, at least one picture uploading task is executed, and the processed picture corresponding to the picture uploading task is uploaded.

3. The method according to claim 1, wherein, after the step that when the idle bandwidth resource exists, the at least one picture downloading task is executed, and the downloaded picture is obtained, the method further comprising:
reexecuting the picture downloading task when any one of the picture downloading tasks fails to be executed; and
generating error downloading information to the task server after the picture downloading task continuously fails to be executed over a first predetermined number of times.

4. The method according to claim 1, wherein, after the step that when the idle bandwidth resource exists, at least one picture uploading task is executed, the processed picture corresponding to the picture uploading task is uploaded, the method further comprising:
reexecuting the picture uploading task when any one of the picture uploading tasks fails to be executed; and
generating error uploading information to the task server after the picture uploading task continuously fails to be executed over a second predetermined number of times.

5. The method according to claim 1, wherein, after the step of generating the picture downloading task, the method further comprising:
adding each picture downloading task into a built picture download queue;
the step that the existence of idle bandwidth resource is detected, when the idle bandwidth resource is greater than the first threshold value, according to download priority from high to low, the at least one picture downloading task is executed, and the downloaded picture corresponding to the picture downloading task is obtained, comprising:
detecting the existence of the idle bandwidth resource, and wherein when the idle bandwidth resource is greater than the first threshold value, the at least one picture downloading task in the download queue is obtained and executed, and the downloaded picture corresponding to the picture downloading task is obtained;
after the step of generating the picture operating task, the method further comprising:
adding each picture operating task into a built picture operate queue;
the step that the existence of the process idle resource is detected, when the process idle resource is greater than the second threshold value, at least one picture operating task is executed, the downloaded picture corresponding to the picture operating task is processed, and the processed picture is obtained, comprising:
detecting the existence of the process idle resource, wherein when the process idle resource is greater than the second threshold value, at least one picture operating task obtained from the picture operate queue is executed, the downloaded picture corresponding to the picture operating task is processed, and the processed picture is obtained;
after the step of generating the picture uploading task, the method further comprising:
adding each picture uploading task into a built picture upload queue;
the step that the existence of the idle bandwidth resource is detected, when the idle bandwidth resource is greater then the third threshold value, at least one picture uploading task is executed, and the processed picture corresponding to the picture uploading task is uploaded, comprising:
detecting the existence of the idle bandwidth resource, wherein when the idle bandwidth resource is greater than the third threshold value, at least one picture uploading task obtained from the picture upload queue is executed, and the processed picture corresponding to the picture uploading task is uploaded.

6. A non-volatile computer storage medium capable of storing computer-executable instructions, the computer-executable instructions are configured for:
obtaining more than two assigned picture processing requests by a picture processing server to generate more than two respective picture downloading tasks;
detecting the existence of idle bandwidth resource, wherein when the idle bandwidth resource is greater than a first threshold value, the at least one picture downloading task is executed, and a downloaded picture corresponding to the picture downloading task is obtained;
generating a picture operating task according to each downloaded picture;
detecting the existence of process idle resource, and wherein when the process idle resource is greater than a second threshold value, at least one picture operating task is executed, the downloaded picture corresponding to the picture operating task is processed, and a processed picture is obtained;
generating a picture uploading task according to each processed picture;
detecting the existence of the idle bandwidth resource, and wherein when the idle bandwidth resource is greater than a third threshold value, at least one picture uploading task is executed, and the processed picture corresponding to the picture uploading task is uploaded.

7. An electronic apparatus, comprising:
at least one processor; and
a memory communicatively connected to the at least one processor; wherein
the memory stores computer-executable instructions which are executable by the at least one processor, when executed by the at least processor, the computer-executable instructions cause the at least one processor to:
obtain more than two assigned picture processing requests by a picture processing server to generate more than two respective picture downloading tasks;
detect the existence of idle bandwidth resource, wherein when the idle bandwidth resource is greater than a first threshold value, the at least one picture downloading task is executed, and a downloaded picture corresponding to the picture downloading task is obtained;
generate a picture operating task according to each downloaded picture;
detect the existence of process idle resource, and wherein when the process idle resource is greater than a second threshold value, at least one picture operating task is executed, the downloaded picture corresponding to the picture operating task is processed, and a processed picture is obtained;
generate a picture uploading task according to each processed picture;
detect the existence of the idle bandwidth resource, and wherein when the idle bandwidth resource is greater than a third threshold value, at least one picture uploading task is executed, and the processed picture corresponding to the picture uploading task is uploaded.

8. The non-volatile computer storage medium according to claim 6, wherein, the step that the existence of idle bandwidth resource is detected, when the idle bandwidth resource is greater than the first threshold value, the at least one picture downloading task is executed, and the downloaded picture corresponding to the picture downloading task is obtained, comprising:
detecting the existence of the idle bandwidth resource, wherein when the idle bandwidth resource is greater than the first threshold value, according to download priority from high to low, the at least one picture downloading task is executed, and the downloaded picture corresponding to the picture downloading task is obtained;
the step that the existence of the process idle resource is detected, when the process idle resource is greater than the second threshold value, at least one picture operating task is executed, the downloaded picture corresponding to the picture operating task is processed, and the processed picture is obtained, comprising:
detecting the existence of the process idle resource, wherein when the process idle resource is greater than the second threshold value, according to operate priority from high to low, at least one picture operating task is executed, the downloaded picture corresponding to the picture operating task is processed, and the processed picture is obtained;
the step that the existence of the idle bandwidth resource is detected, when the idle bandwidth resource is greater than the third threshold value, at least one picture uploading task is executed, and the processed picture corresponding to the picture uploading task is uploaded, comprising:
detecting the existence of the idle bandwidth resource, and wherein when the idle bandwidth resource is greater than the third threshold value, according to upload priority from high to low, at least one picture uploading task is executed, and the processed picture corresponding to the picture uploading task is uploaded.

9. The non-volatile computer storage medium according to claim 6, wherein, after the step that when the idle bandwidth resource exists, the at least one picture downloading task is executed, and the downloaded picture is obtained, the computer-executable instructions are further configured for:
reexecuting the picture downloading task when any one of the picture downloading tasks fails to be executed; and
generating error downloading information to the task server after the picture downloading task continuously fails to be executed over a first predetermined number of times.

10. The non-volatile computer storage medium according to claim 6, wherein, after the step that when the idle bandwidth resource exists, at least one picture uploading task is executed, the processed picture corresponding to the picture uploading task is uploaded, the computer-executable instructions are further configured for:
reexecuting the picture uploading task when any one of the picture uploading tasks fails to be executed; and
generating error uploading information to the task server after the picture uploading task continuously fails to be executed over a second predetermined number of times.

11. The non-volatile computer storage medium according to claim 6, wherein, the computer-executable instructions are further configured to:
add each picture downloading task into a built picture download queue;
the step that the existence of idle bandwidth resource is detected, when the idle bandwidth resource is greater than the first threshold value, the at least one picture downloading task is executed, and the downloaded picture corresponding to the picture downloading task is obtained, comprising:
detecting the existence of the idle bandwidth resource, and wherein when the idle bandwidth resource is greater than the first threshold value, the at least one picture downloading task in the download queue is obtained and executed, and the downloaded picture corresponding to the picture downloading task is obtained;
after the step of generating the picture operating task, the computer-executable instructions are further configured to:
add each picture operating task into a built picture operate queue;
the step that the existence of the process idle resource is detected, when the process idle resource is greater than the second threshold value, at least one picture operating task is executed, the downloaded picture corresponding to the picture operating task is processed, and the processed picture is obtained, comprising:
detecting the existence of the process idle resource, wherein when the process idle resource is greater than the second threshold value, at least one picture operating task obtained from the picture operate queue is executed, the downloaded picture corresponding to the picture operating task is processed, and the processed picture is obtained;
after the step of generating the picture uploading task, the computer-executable instructions are further configured to:
add each picture uploading task into a built picture upload queue;
the step that the existence of the idle bandwidth resource is detected, when the idle bandwidth resource is greater then the third threshold value, at least one picture uploading task is executed, and the processed picture corresponding to the picture uploading task is uploaded, comprising:
detecting the existence of the idle bandwidth resource, wherein when the idle bandwidth resource is greater than the third threshold value, at least one picture uploading task obtained from the picture upload queue is executed, and the processed picture corresponding to the picture uploading task is uploaded.

12. The electronic apparatus according to claim 7, wherein, the step that the existence of idle bandwidth resource is detected, when the idle bandwidth resource is greater than the first threshold value, the at least one picture downloading task is executed, and the downloaded picture corresponding to the picture downloading task is obtained, comprising:
detecting the existence of the idle bandwidth resource, wherein when the idle bandwidth resource is greater than the first threshold value, according to download priority from high to low, the at least one picture downloading task is executed, and the downloaded picture corresponding to the picture downloading task is obtained;
the step that the existence of the process idle resource is detected, when the process idle resource is greater than the second threshold value, at least one picture operating task is executed, the downloaded picture corresponding to the picture operating task is processed, and the processed picture is obtained, comprising:
detecting the existence of the process idle resource, wherein when the process idle resource is greater than the second threshold value, according to operate priority from high to low, at least one picture operating task is executed, the downloaded picture corresponding to the picture operating task is processed, and the processed picture is obtained;
the step that the existence of the idle bandwidth resource is detected, when the idle bandwidth resource is greater than the third threshold value, at least one picture uploading task is executed, and the processed picture corresponding to the picture uploading task is uploaded, comprising:
detecting the existence of the idle bandwidth resource, and wherein when the idle bandwidth resource is greater than the third threshold value, according to upload priority from high to low, at least one picture uploading task is executed, and the processed picture corresponding to the picture uploading task is uploaded.

13. The electronic apparatus according to claim 7, wherein, after the step that when the idle bandwidth resource exists, the at least one picture downloading task is executed, and the downloaded picture is obtained, the instructions are further configured for:
generating error downloading information to the task server after the picture downloading task continuously fails to be executed over a first predetermined number of times.

14. The electronic apparatus according to claim 7, wherein, after the step that when the idle bandwidth resource exists, at least one picture uploading task is executed, the processed picture corresponding to the picture uploading task is uploaded, the instructions are further configured for:
reexecuting the picture uploading task when any one of the picture uploading tasks fails to be executed; and
generating error uploading information to the task server after the picture uploading task continuously fails to be executed over a second predetermined number of times.

15. The electronic apparatus according to claim 7, wherein, the instructions are further configured for:
adding each picture downloading task into a built picture download queue;
the step that the existence of idle bandwidth resource is detected, when the idle bandwidth resource is greater than the first threshold value, the at least one picture downloading task is executed, and the downloaded picture corresponding to the picture downloading task is obtained, comprising:
detecting the existence of the idle bandwidth resource, and wherein when the idle bandwidth resource is greater than the first threshold value, the at least one picture downloading task in the download queue is obtained and executed, and the downloaded picture corresponding to the picture downloading task is obtained;
after the step of generating the picture operating task, the instructions are further configured for:
adding each picture operating task into a built picture operate queue;
the step that the existence of the process idle resource is detected, when the process idle resource is greater than the second threshold value, at least one picture operating task is executed, the downloaded picture corresponding to the picture operating task is processed, and the processed picture is obtained, comprising:
detecting the existence of the process idle resource, wherein when the process idle resource is greater than the second threshold value, at least one picture operating task obtained from the picture operate queue is executed, the downloaded picture corresponding to the picture operating task is processed, and the processed picture is obtained;
after the step of generating the picture uploading task, the instructions are further configured for:
adding each picture uploading task into a built picture upload queue;
the step that the existence of the idle bandwidth resource is detected, when the idle bandwidth resource is greater then the third threshold value, at least one picture uploading task is executed, and the processed picture corresponding to the picture uploading task is uploaded, comprising:
detecting the existence of the idle bandwidth resource, wherein when the idle bandwidth resource is greater than the third threshold value, at least one picture uploading task obtained from the picture upload queue is executed, and the processed picture corresponding to the picture uploading task is uploaded.
